(19) United States
(12) Patent Application Publication
(10) Pub. No.: US 2023/0339078 A1
(43) Pub. Date: Oct. 26, 2023

(54) MOUNTING TABLE FOR MANUFACTURING A PANEL ASSEMBLY

(71) Applicant: Leko Labs S.A., Foetz (LU)

(72) Inventors: François-Xavier CORDIER, Strassen (LU); Matteo FERRARI, Bereldange (LU); Catarina CARVALHEIRAS, Esch-Sur-Alzette (LU)

(21) Appl. No.: 18/044,873

(22) PCT Filed: Sep. 10, 2021
(86) PCT No.: PCT/EP2021/025339

§ 371 Date: Mar. 10, 2023

(30) Foreign Application Priority Data
Sep. 11, 2020 (EP) 20315407.5

(51) Int. Cl. B25B 11/00

(52) U.S. Cl. CPC B25B 11/005

(57) ABSTRACT

Mounting table for manufacturing a panel assembly which includes a plurality of superimposed layers wherein the mounting table includes a holding structure oriented at least partially vertically, a set of suction cups secured to the front side of the holding structure, a set of fixed spacers arranged between suction cups, a channel to let the air flow from the suction cups, and an air outlet arranged to generate vacuum through the channel, arranged so that the first layer of the panel assembly is secured at least partially vertically to the front side of the holding structure by means of the suction cups, while the next layers are securely attached to each other, and so that the weight of the overall panel assembly can be held by the mounting table.

### BACKGROUND

The present disclosure relates to the manufacturing of a wooden panel assembly, such as for the manufacturing of construction systems. In particular, the present disclosure intends to permit the manufacturing of large and heavy panel assemblies, such as when they are made of a series of superimposed layers that comprise a series of wooden elements and insulation elements. Such elements usually have the shape of “slats”. Such panels are known in the field as “Cross-Laminated Timber” or “CLT”.

When it comes to manufacturing a large and heavy panel assembly, difficulties arise in terms of handling the panel, which usually leads to seek a balance between complying with security requirements and logistics and transportation restrictions, on the one hand, and manipulating the panel with enough accuracy, on the other hand.

To manufacture a panel assembly, the most conventional known technique consists of using a horizontal table, and superimposing the successive layers and elements of the panel on each other by means of robots, thus taking advantage of gravity to stabilize and naturally secured the layers and elements to each other. This technique is used by companies such as Kuka (see video untitled “Flower power timber robots: How robots can revolutionize architecture and timber industry” on the Youtube platform at the address https://www.youtube.com/watch?v=bVVNQ5-3tjw). However, such device is not adapted for all applications, especially for applications where the wooden elements need to be operated on both sides (for instance for stapling the elements). The robots of such device also appear to manipulate small parts having the same sizes and configurations.

To allow such manipulation on both sides, it is known to flip the panel during the manufacturing process, so the workers can access the other side previously covered. This solution may appear natural, as in any case, once the panel is assembled, the finished product must be tilted vertically to be stored and properly transported by trucks. This flipping technique is used by companies such as Modular Building Automation (see video untitled “Timber Frame Butterfly Table” on the Youtube platform at the address https://www.youtube.com/watch?v=a8BMq1CeMi0). However, flipping means make the mounting table even more complex, significantly slow down the manufacturing process with multiple flipping steps, and generate additional higher risks of falling.

These known techniques thus have several drawbacks. First, as they operate horizontally, they require a huge space on the floor to host large machinery. Second, they are slow and prone to fail, so a balance must be found between speed and accuracy of the assembling. This is all the more instrumental that the assembling step is known to be the biggest bottleneck of the manufacturing cycle. In the same time, depending on the structure of the panel assembly, a high assembly accuracy may be need. In many CLT panels, where parts of the panel are trimmed after the assembling or on site, a relatively low precision (in the range of several millimeters) may be enough. However, in some CLT panels, especially when the surfaces of the elements are laminated, the elements need to be positioned relatively to each other with high precision.

Another technique uses mechanical holding means. DE 3628428 C2 indeed discloses another known technique, which makes use of a set of suction cups arranged in multiple rows on a base frame. However, the base frame is mounted horizontally, and it is not intended to bear a panel assembly, and even less a large and heavy panel assembly, which leads to safety issues.

When the assembly becomes large and heavy, the suction cups are usually not considered as the appropriate solution. This is why such means are rather used in other applications, for instance for the bowing of canned beverages. CN 105035402 B indeed discloses a multi-suction tray packing mechanism for canned beverages, which includes a plurality of suction cup assemblies, each of them being controlled by a telescopic mechanism, so that they can be moved independently from each other and several boxes can be made simultaneously.

Overall, there is a need for a universal mounting table that is adapted to any size and weight of panel assembly, from small to large, regardless of the number of wooden elements, as well as their dimensions, positions, orientations, or patterns.

### SUMMARY

It is accordingly an object of the present disclosure to provide a mounting table for manufacturing a panel assembly, which may (i) allow a fast and easy assembling of the layers and elements, (ii) be universal in that it can safely hold even heavy and large panel assemblies (even in case they have a high part-to-part dimensional difference), (iii) ensure high precision and reliability during the assembling of the layers and elements, or combinations thereof.

To this end, the present disclosure relates to a mounting table for manufacturing a panel assembly, wherein the panel assembly includes a plurality of superimposed layers secured to each other, and the mounting table is arranged on the back side of the panel assembly so that the panel assembly can be assembled from the front side of the panel assembly. According to the disclosure, the mounting table may include a holding structure oriented at least partially vertically, and having a front side and a back side, a set of suction cups secured to the front side of the holding structure, a set of fixed spacers secured to the front side of the holding structure, and arranged between suction cups, as well as means arranged on the back side of the holding structure for generating vacuum through from the suction cups. The mounting table may be arranged so that the first layer of the panel assembly is secured at least partially vertically to the front side of the holding structure by means of the suction cups, while the following layers are securely attached to each other, and so that the weight of the overall panel assembly can be held by the mounting table.

As the holding structure is oriented at least partially vertically, the mounting table may save space on the floor. Additionally or alternatively, it may be possible to minimize the operations requiring access from backside of the panel assembly, so robots can proceed with the assembling from only one side. Additionally or alternatively, the panel assembly as a finished product may be oriented at least partially vertically, which makes it easier to store and transport. Thus, it may be possible to avoid flipping the panel assembly, either during its manufacturing, or during its storing. Additionally or alternatively, the production time and/or the complexity of the system may be reduced.

The specific arrangement of suction cups and spacers may allow the mounting table to safely secure and hold the panel assembly, as panel is being assembled, even in case the panel assembly is large and heavy. The spacers may keep a distance between each of the suction cups, offer axial sustaining counterforce and add lateral friction force, which may mitigate the elastic deflection of the suction cups along gravity direction, which ultimately may yield to minimal undesired positional displacement. They thus may relieve some of the stress on the suction cups. This specific arrangement thus may be adapted to the panels to be assembled, and it may take full benefit of vacuum as holding means, contrary to the known vacuum techniques that were not designed to bear such heavy elements. The risks that the panel falls may therefore be significantly reduced, and safety increased.

Additionally or alternatively, the accuracy of assembling of the panel may be increased, thanks to the ability to secure the panel. This means that panel assemblies can be produced, even in case some layers include wooden elements that have been laminated and thus requires a more precise relative positioning of the elements. The mounting table may thus be more universal and versatile, as it can be used to manufacture not only small and lights panels, but also large and heavy one (which would be a worst-case scenario), and also to manufacture panels with multi-layers and cross-laminated elements such as the known “CLT” panels.

Optionally, the spacers are distributed homogeneously along the front side of the holding structure.

Optionally, the holding structure is divided into a set of vacuum modules. In this case, the vacuum capacity of each vacuum module) can be adapted separately from the vacuum capacity of the other vacuum modules. The variations between each area of the holding structure can be minimized, and be adapted to geometrical requirements and constraints. In each vacuum module, the suction cups may also be arranged in a matrix of rows and columns, which may offer a proper granularity of the mounting table in order to secure all the elements of the first layer of the panel.

Optionally, the first layer of the panel assembly includes a series of wooden elements and insulation elements, the size of the suction cups and the distance between two adjacent suction cups are determined so that the wooden elements and the insulation elements can be held by at least some of the suction cups. This pattern of the suction cup arrangement, driven by the width of the wooden elements, may allow to have full contact surface of the suction cups with the wooden elements, regardless the position of the wooden elements on the holding structure. The mounting table may thus be adaptable to any type of panel assembly.

Optionally, the spacers include a hardened heavy-duty rubber sustained by a steel body attached the holding structure.

Optionally, at least some of the layers (or even all of them) include a series of elements and insulation elements.

Optionally, the mounting table includes a self-cleaning mechanism arranged to sneeze out a possible dust particle that may have been collected during the manufacturing of the panel assembly, while continuously intaking air to generate vacuum. Thanks to this self-cleaning mechanism, dust particles resulting from the on-going operations (i.e. screwing the wooden elements to each other) can be sneezed out and collected before the assembling steps. The presence of dust particles can thus be limited or avoided during the manufacturing.

The mounting table may include an electrically controlled valve which is operated to switch between three air states, a first one being “off”, the second one being “vacuum”, and the third one being “sneeze out”, and which is programmed to handle the manufacturing of the panel assembly.

Optionally, the mounting table includes a framework on which the holding structure is attached, and a fail-safe mechanism arranged on the top side of the framework, in order to fix the panel assembly and counteract a possible failure of the panel assembly.

The fail-safe mechanism optionally sits on rails and is arranged in order to roll along the rails in order to be positioned above the center of gravity of the panel assembly.

Optionally, the holding structure is vertically oriented. This orientation may lower the footprint on the panel assembly, and/or may be safer as the panel does not need to be flipped during the manufacturing.

The disclosure also relates to a system for manufacturing a panel assembly, including a mounting table according to the disclosure, and a set of robots arranged to assemble each layer of the panel assembly.

The disclosure also relates to a method for manufacturing a panel assembly by means of a system according to the disclosure, including the steps of:
generating a constant vacuum through the suction cups;
arranging the first layer on the suction cups;
arranging each subsequent layer on the preceding layer; and
securing the adjacent layers to each other with screwing means.

The disclosure also relates to a panel assembly manufactured according to the method of the present disclosure.

It also an object of the present disclosure to provide a mounting table for manufacturing a panel assembly comprised of a plurality of superimposed layers, the mounting table comprising:
a holding structure having a front side and a back side;
a plurality of suction cups secured to the front side of the holding structure;
a plurality of fixed spacers secured to the front side of the holding structure and arranged between the plurality of suction cups;
a channel configured to let the air flow from the plurality of suction cups to the back side of the holding structure; and
an air outlet configured to generate vacuum through the channel;
wherein the mounting table is configured to secure a first layer of the panel assembly to the front side of the holding structure via the suction cups and wherein the mounting table is configured to support a weight of the panel assembly including the plurality of superimposed layers.

Optionally, one or more of the following may be applicable:
the spacers are distributed homogeneously along the front side of the holding structure;
the holding structure is divided into a plurality of vacuum modules;
the vacuum capacity of each vacuum module is configurable separately from the vacuum capacity of the other vacuum modules;
the plurality of suction cups are arranged in a matrix of rows and columns within each vacuum module;
the panel assembly comprises a plurality of wooden elements and a plurality of insulation elements and wherein a size of the suction cups and a distance between adjacent suction cups is configured such that at least a portion of the wooden elements and at least a portion of the insulation elements are held by at least a portion of the suction cups;
the spacers comprise a hardened heavy-duty rubber sustained by a steel body attached the holding structure;
the mounting table further comprises a self-cleaning mechanism configured to sneeze out any dust particle that collected during the manufacturing of the panel assembly while continuously intaking air to generate vacuum;
the self-cleaning mechanism comprising an electrically controlled valve programmed to handle different phases of the manufacturing of the panel assembly and operable to switch between three air states: an off state, a vacuum state, and a sneeze-out state;
the mounting table further comprises a framework on which the holding structure is attached, and a fail-safe mechanism arranged on the top side of the framework, the fail-safe mechanism being configured to further secure the panel assembly to the mounting table;
the fail-safe mechanism sits on rails and is configured to roll along the rails to be positioned above the center of gravity of the panel assembly;
the holding structure is configured to secure the panel assembly in a vertical orientation such that a plane corresponding to the panel assembly is perpendicular to a ground plane.

It is also an object of the present disclosure to provide a system for manufacturing a panel assembly, the system comprising:
a holding structure having a front side and a back side;
a plurality of suction cups secured to the front side of the holding structure;
a plurality of fixed spacers secured to the front side of the holding structure and arranged between the plurality of suction cups;
a channel configured to let the air flow from the plurality of suction cups to the back side of the holding structure; and
an air outlet configured to generate vacuum through the channel;
wherein the mounting table is configured to secure a first layer of the panel assembly to the front side of the holding structure via the suction cups and wherein the mounting table is configured to support a weight of the panel assembly including the plurality of superimposed layers; and
a plurality of robots configured to assemble each subsequent layer of the panel assembly when the first layer of the panel assembly is secured to the front side of the holding structure.

It is another object of the present disclosure to provide a method for manufacturing a panel assembly, the method comprising:
generating, by a vacuum pump, a constant vacuum through a plurality of suction cups secured to a front side of a holding structure on a mounting table to thereby secure a first layer of a panel assembly to the front side of the holding structure, wherein a channel on the holding structure is configured to let air flow from the plurality of suction cups to the back side of the holding structure and to an air outlet coupled to the vacuum pump;
arranging a plurality of wooden elements and a plurality of insulation elements of the first layer of the panel assembly on the suction cups;
assembling, by a plurality of robots, each subsequent layer of the panel assembly when the first layer of the panel assembly is secured to the front side of the holding structure;
arranging the plurality of wooden elements and the plurality of insulation elements of each subsequent layer of the panel assembly on a preceding layer of the panel assembly; and
coupling adjacent layers of the panel assembly to each other.

### BRIEF DESCRIPTION OF DRAWINGS

Other features and advantages of the disclosure will become apparent from the following description of embodiments of the disclosure, given for illustrative purposes, by reference to the annexed drawings.

FIG. 1 is a perspective view of the front side of a mounting table according to an embodiment of the present disclosure.

FIG. 2 is a perspective view of the back side of a mounting table of FIG. 1.

FIG. 3 is a perspective view of a known construction system.

FIG. 4A is a perspective view of a known panel assembly (only with wooden elements, i.e. without insulation elements).

FIG. 4B is a perspective view of a known panel assembly (with both wooden elements and insulation elements).

FIG. 5 is a partial perspective view of the front side of the holding structure.

FIG. 6 is a partial front view of the front side of the holding structure, with a set of wooden elements being secured to the holding structure.

FIG. 7 is a perspective view of the front side of the holding structure.

FIG. 8 is a front view of the front side of the holding structure.

FIG. 9 is a partial perspective view of the back side of the holding structure.

FIG. 10 is a partial perspective view of the back side of the holding structure.

FIG. 11 is a partial perspective view of the back side of the holding structure, with a panel assembly secured to the holding structure.

FIG. 12 is a partial lateral view of the holding structure and panel assembly.

FIG. 13 is a perspective view of the front side of the holding structure arranged to receive a large panel assembly.

FIG. 14 is a perspective view of the back side of the holding structure of FIG. 13.

FIG. 15 is a perspective view of the front side of the holding structure arranged to receive a small panel assembly.

FIG. 16 is a partial perspective view of the back side of the holding structure of FIG. 15.

FIG. 17 is a perspective view of the front side holding structure arranged to receive an intermediary panel assembly.

FIG. 18 is a front view of the back side of the holding structure of FIG. 17.

FIG. 19 is a perspective view of the front side of the fail-safe mechanism.

FIG. 20 is a perspective view of the back side of the fail-safe mechanism.

FIG. 21 is a lateral sectional view of a spacer.

FIG. 22 is a rear sectional view of a spacer.

### DETAILED DESCRIPTION

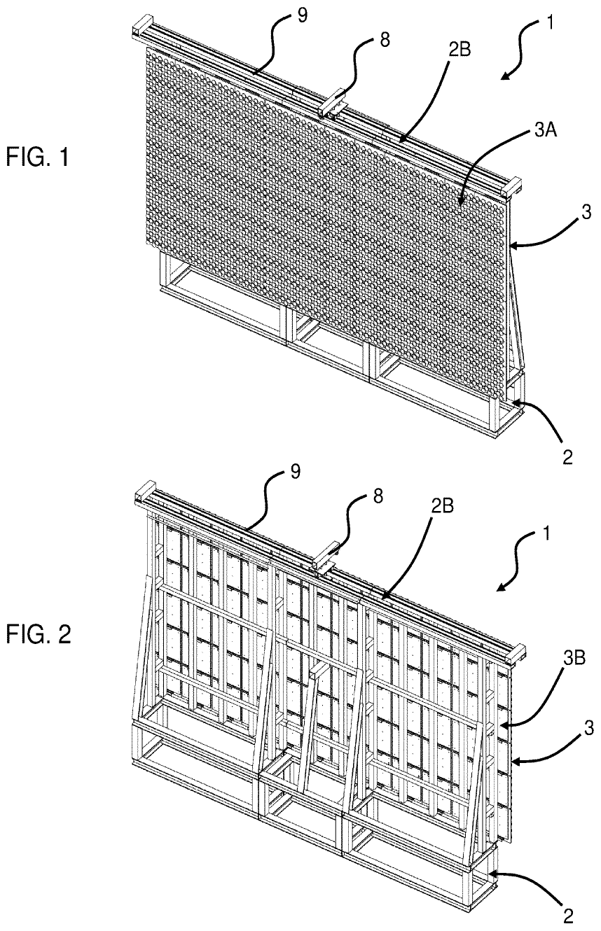

Referring now to FIG. 1 and FIG. 2, the mounting table 1 comprises a metal framework 2 designed to maintain a vertical holding structure 3. The structure 3 is vertically oriented in this example, but it can be oriented differently, as long as it is not oriented horizontally. Indeed, floor space requirements and panel assembly footprint decrease as the holding structure 3 approaches the vertical orientation. The holding structure 3 has a “front side” 3A (where the panel assembly will be attached to the structure 3), and a “back side” 3B (where the structure 3 is attached to the framework 2).

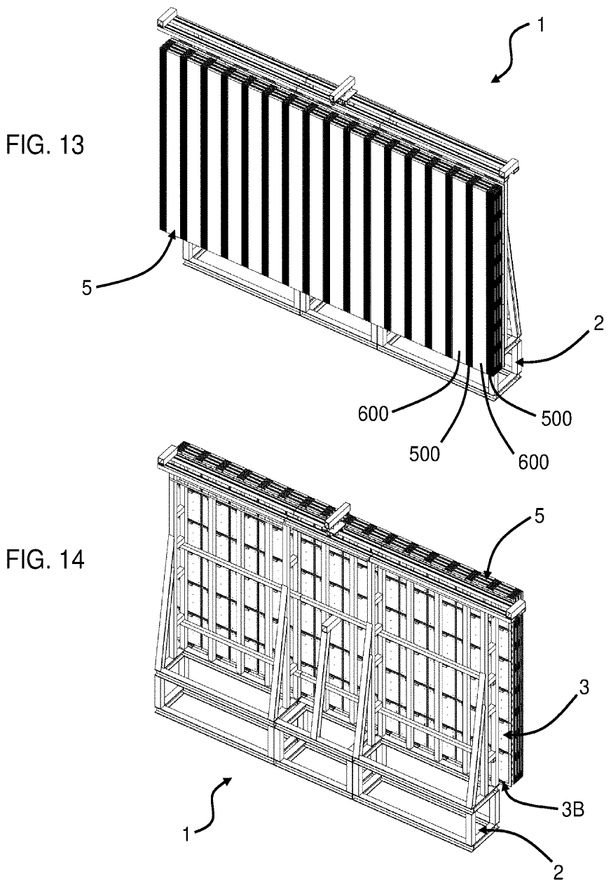

The mounting table 1 is intended for the handling and the manufacturing of a panel assembly such as the panel assemble 5 of FIGS. 4A and 4B. This panel assembly, also known as “Cross-Laminated Timber” or “CLT”, is made of a series of layers 50, 51, 52, 53 . . . . There are eight layers on FIG. 4A. These layers are “superimposed”, which means that they are disposed on one another (without this being interpreted as the panel being necessarily horizontally oriented). In details, each layer is made of a series of wooden elements (or “slats”). The first layer 50 comprises wooden elements 501, 502, 503, 504, 505, 506 and 507. The second layer 51 comprises wooden elements 511, 512, 513, 514 and 515, which are orthogonal to the wooden elements 501, 502, 503, 504, 505, 506 and 507 (but other arrangements can be achieved, e.g. non-orthogonal arrangements of elements from one layer to the following, depending on the purpose and performance of the panel assembly). These elements are also visible on FIG. 13 with reference 500. The same applies to the other layers and wooden elements. The layers are thus “crossed” in that the wooden elements of a given layer are orthogonal to the wooden elements of the adjacent layers. The wooden elements fulfil a structural function.

As can be seen on FIG. 4B, between at least some of the wooden elements (or between all of them), insulation elements 601, 602, 603, 604, 605 and 606 can be inserted. These elements are also visible on FIG. 13 with reference 600. Such insulation elements fulfil a function of insulating the panel, from an acoustic and/or thermal perspective.

The panel assembly 5 can be “laminated”, (the surface of at least some of its wooden elements 501, 502 . . . can be laminated) in order to provide means to avoid the two adjacent wooden elements will slides relatively to each other at the level of their contact interface. An example of such lamination is the providing of grooves on the surface of certain wooden elements, such as on the front side of an element and on the back side of an adjacent element, so that the respective grooves interact with each other and thus reduce or prevent sliding. Other means can also be used to limit or avoid such sliding, for instance gluing the wooden elements with each other, in addition to screwing means that may in any event be used to fix the wooden elements together and secure the successive layers with each other. It is understood that when the elements are laminated, the elements need to be assembled with high precision, for instance in order to insert the grooves of one element within the slots of an adjacent element.

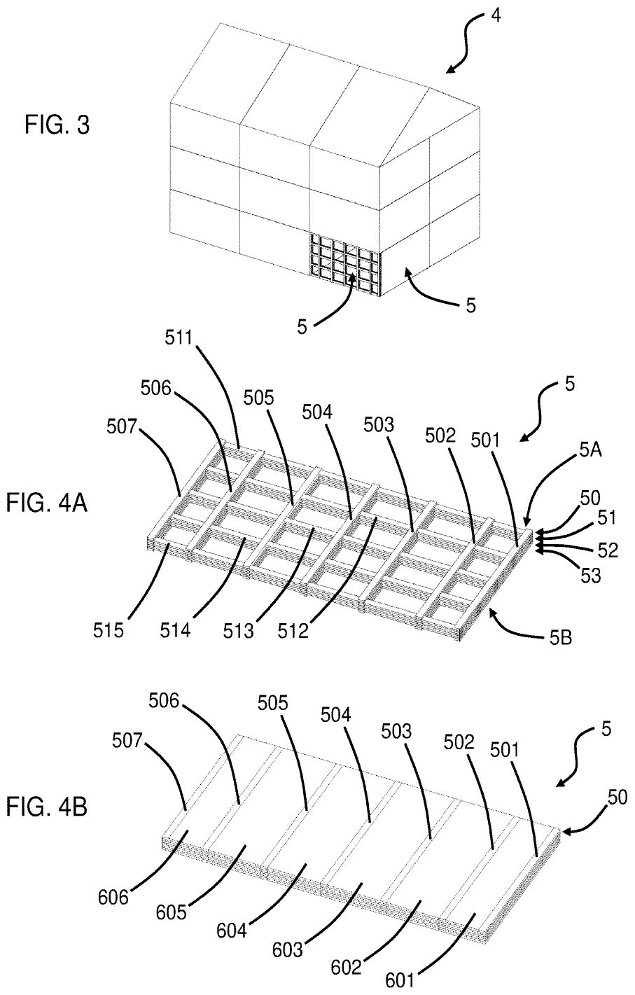

The panel 5 can be used to assemble a construction system 4, such as a house or a building, as the one of FIG. 3. The system 4 is thus made of a series of panels 5, that can be identical or different, depending on the required characteristics, notably all the structural requirements of construction systems. The division of such system into a set of adjacent panels 5 is made according to a rationale, including the size of the panels to be transported on site, and the unity of the system.

The panel assembly 5 has a front side 5A (where the first layer 50 is located) and a back side 5B (where the last layer of the panel is located). The front side 5A is secured to the holding structure 3, while the panel assembly 5 will be assembled from its back side 5B, layer by layer, from the first to the last layer.

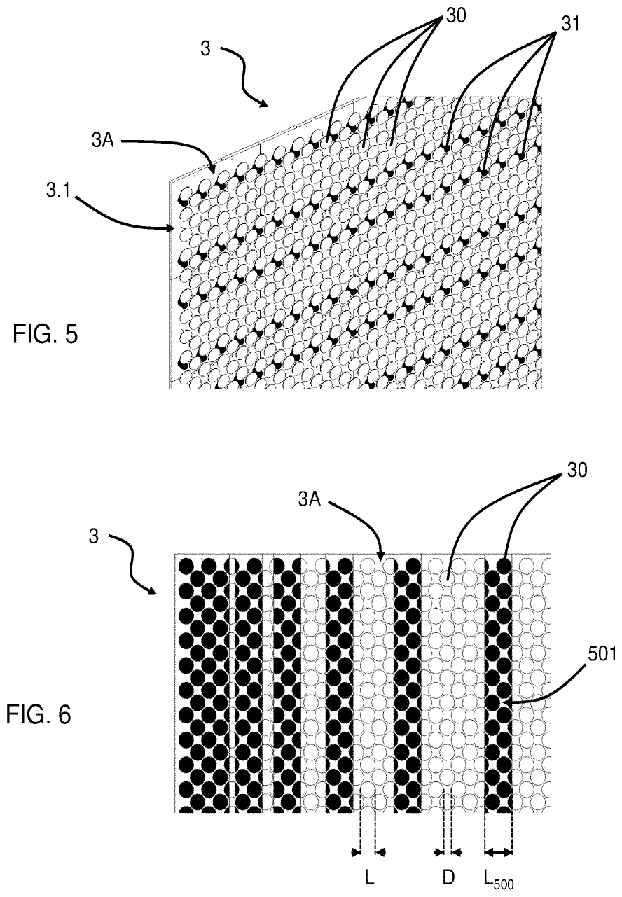

Turning back to the holding structure 3, the front side the holding structure 3A is represented in more details on FIG. 5. A set of suction cups 30 is secured to the front side 3A, and is homogenously disposed along the front side 3A. These suction cups, well-known as such in the art, may be arranged in various ways on the holding structure. They may be arranged as a matrix of raw and columns, or like on FIG. 5 in series of lines tilted from each other in order to cover more space on the front side 3A, and so to increase the density of suction cups. But the skilled person will be able to find other arrangements depending on the contemplated application.

In order to offer a satisfying granularity for wooden elements over large range(s) of width and/or length, a total of 3500 suction cups may be homogenously distributed along the holding structure. A typical wooden element width is around 120 millimeters.

No matter what arrangement of the suction cups 30 is chosen, the suction cups 30 may be close enough to each other in order to have a density of suction cups adapted to the size of the wooden elements. As illustrated on FIG. 6, the wooden element 501 (overprinted) has a width L₅₀₀. The suction cup should have a size or diameter L that is inferior to this width and a space between two adjacent suction cups D, and possibly significantly inferior to this width, so that a wooden element of the panel assembly—for example, the wooden elements of the first layer 50, such as wooden element 501, as these are wooden elements that will be directly secured to the front side 3A—covers several suction cups 30. By doing so, the mounting table 1 may be able to hold the wooden element with multiple suction cups.

It is noted here that a suction cup must be fully covered by the wooden element so that the vacuum can be properly generated and that the wooden element is indeed secured by means of the vacuum, while partially covered suction cups do not allow vacuum to be generated due to the lack of sealed lip. It is also noted that the insulation elements do not contribute to the securing of the panel assembly, since their high porosity are not suitable for vacuum handling. For the panel of FIG. 4, it is thus noted that only a small portion of the suction cups are “used” to maintain the panel assembly (because of the number and width of the wooden elements of the first layer), even if the panel assembly as a whole can be large and heavy.

This arrangement and density of suction cups may ensure that the adequate minimum suction force is applied on the wooden elements under a wide range of circumstances. In the example of FIG. 6, the arrangement of the suction cups as several series, tilted from each other, may ensure enough density of the suction cups to secure even wooden elements with a small width. In the configuration of FIG. 6, at least one full row of suction cups may always in full contact with the wooden elements, regardless of the position of the wooden elements.

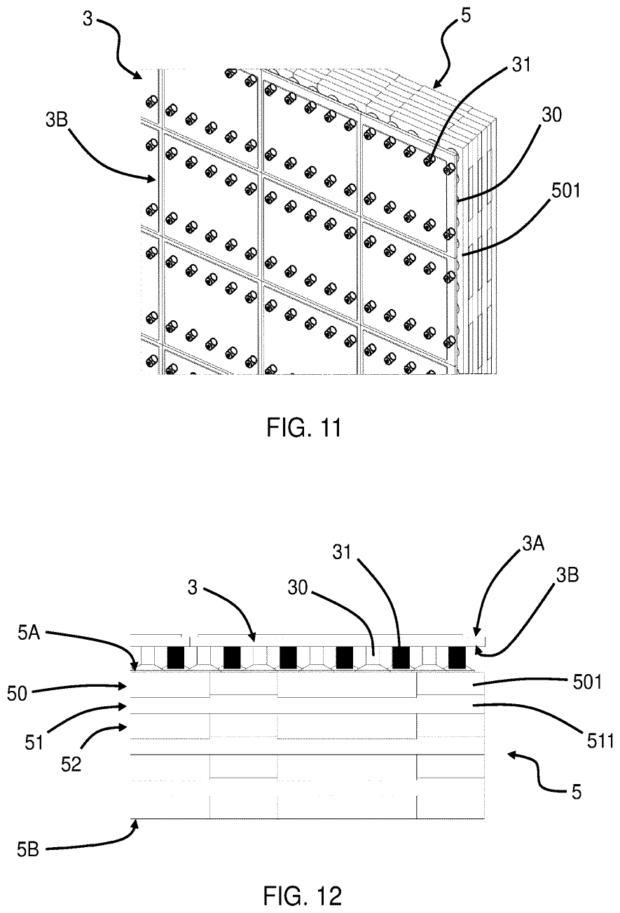

As can been seen on FIG. 5, a set of fixed spacers 31 are secured to the front side of the holding structure 3A. These spacers 31 are arranged between some of the suction cups 30. They are also visible on FIG. 11 and FIG. 12. The function of the spacers 31 is to maintain a distance between the suction cups 30 of the holding structure. Indeed, the spacers 31 are rigid enough to counter the weight of the panel assembly on the suction cups 30, and thus to mitigate the elastic deflection of the suction cups along gravity direction. The spacers 31 thus avoid or limit any displacement of the suction cups 30 due to the weight of the panel assembly 5. They thus relieve a part of the stress which is usually on the suction cups 30.

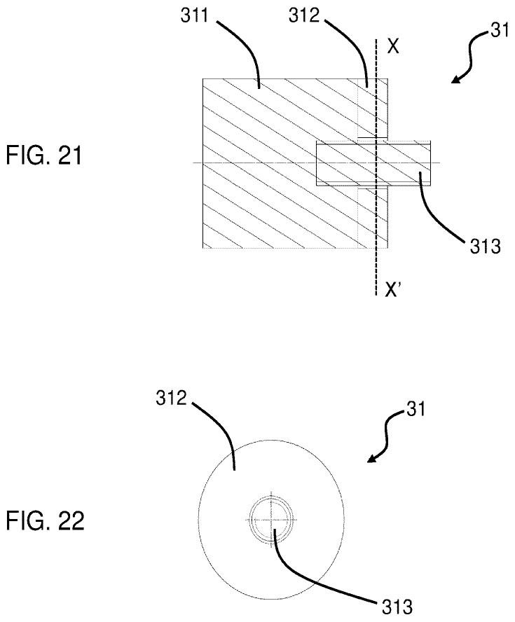

As an example, the spacers 31 may include a hardened heavy-duty rubber sustained by a steel body attached to the holding structure. An example of spacer is given with reference to FIG. 21 and FIG. 22. The spacer 31 includes a hardened heavy-duty rubber 311, in the direction of the panel assembly. In this example, the rubber 311 has a circular shape, but another appropriate shape may be used. The rubber 311 is sustained by a steel body 312. The body 312 may be made of Steel S235JR, with a circular shape identical to the one of the rubber 311. In addition, the body 312 is attached to the holding structure 3 by means of a screw 313, which is screwed into the front side 3A of the holding structure.

A strong maintaining of the panel assembly can be obtained when a total of around 700 spacers are provided for a total of around 3500 suction cups. Like the suction cups, the spacers are optionally homogenously distributed along the holding structure 3. The use of such spacers may allow the level of precision which is needed when it comes to positioning and assembling the wooden elements.

The arrangement of the suction cups 30 and the spacers 31 is determined in order to meet several requirements. For instance, this arrangement may be able to secure even small wooden elements to the holding structure 3, which requires a high density of suction cups 30. Also, it should avoid any displacement of the suction cups 30 due to a heavy panel assembly, which requires a certain density of spacers as well.

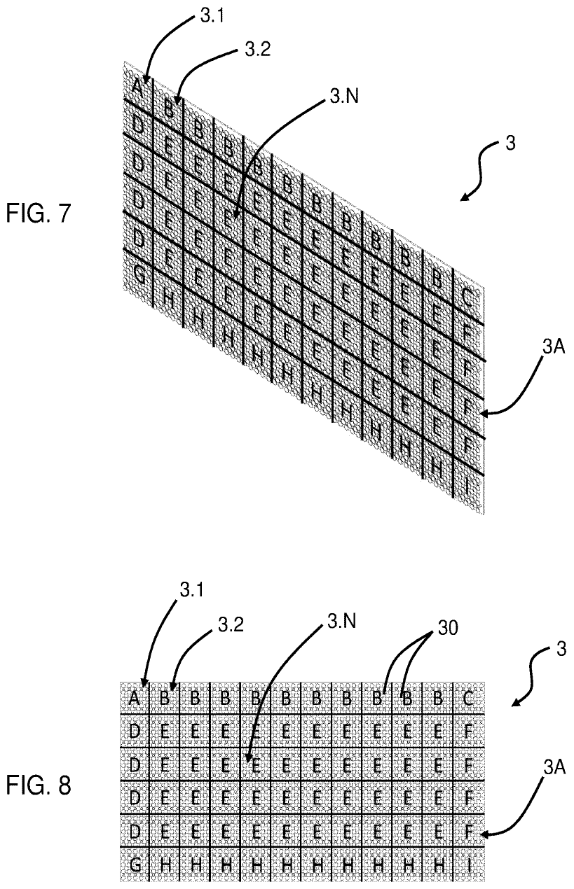

Turning back to FIG. 7 and FIG. 8, the front side of the holding structure 3A can be divided into a set of vacuum modules 3.1, 3.2 . . . , 3.N . . . . In this example, a total of 72 vacuum modules are provided (6 vacuum modules along the height, 12 vacuum modules along the length of the holding structure). For each of the vacuum modules, a set of suction cups 30 and spacers 31 is provided. The arrangement of suction cups and spacers can be the same for each vacuum module, as shown on FIG. 8, or it can be different, depending on the contemplated application. The modules can be different from each other, or they can be categorized, for instance the 72 vacuum modules may be ranged into nine different categories to comply with the geometrical requirements and constraints of the panel assembly. Other advantages of arranging the holding structure in a set of vacuum modules are its higher serviceability (since in case of failure only the faulty vacuum module can be repaired or replaced), and its easier assembling (thanks to lighter and smaller sections to be handled).

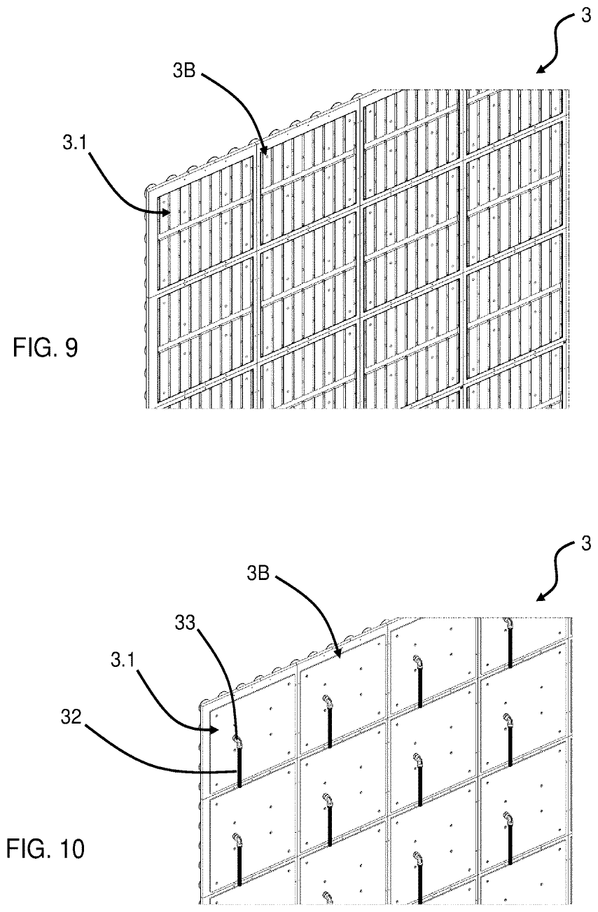

As can be seen on FIG. 9 and FIG. 10, the back side of the holding structure 3B is divided into the same set of vacuum modules, with a network of channels and air outlets. In details, a channel 32 is provided for each vacuum module to let the air flow from the suction cups 30 of this vacuum module to the back side of the holding structure 3B. An air outlet 33 is also provided to generate vacuum through the channel 32. Thanks to this arrangement, each of the vacuum modules 3.1, 3.2 . . . , 3.N . . . can be operated separately, by means of the channel 32 and the air outlet 33 of this vacuum module, so that the functioning of each module can be adapted depending on the size and the position of the panel to be assembled. For example, if the panel assembly 5 only covers half of the holding structure 3, vacuum should be generated in only half of the vacuum modules, while the other should remain inactive.

On FIG. 10, one can see a series of channels 32 and air outlets 33 on the back side of the vacuum modules. These channels 32 are all connected to a vacuum pump intended to generate vacuum by sucking air, which is not visible on this figure (for the sake of clarity), and which can be a commercially available vacuum pump depending on the required characteristics and performance. The vacuum pump is connected to channels 32 through a manifold connector, i.e. a connector with a single input line and multiple output lines.

The mounting table 1 can be used to manufacture panel assemblies having different sizes. For instance, as shown on FIG. 13 and FIG. 14, a panel assembly 5 covering the whole holding structure 3 can be manufactured. In this case, the whole holding structure 3 is solicited. The panel assembly is made of 8 layers, each layer including a succession of wooden elements 500 (here, “500” refers indistinctly to any of the wooden elements 501, 502, 503 . . . ) and insulation elements 600. This situation may be considered as a “worst-case scenario”, since the panel assembly is large and potentially heavy. Typically, such panel assembly may span a width of 6 meters, a height of 3 meters, and a thickness of 8 layers. This may lead to a total weight of approximately 1500 kilograms (including the wooden elements, the insulation elements, and the screws).

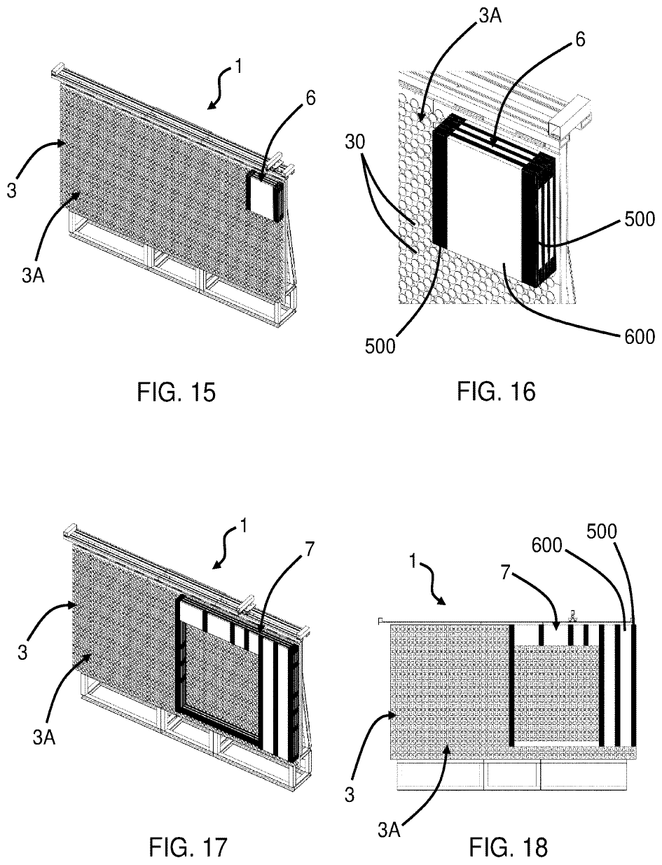

The mounting table 1 can also be used for very small panel assemblies such as the panel 6 of FIG. 15 and FIG. 16. In this case, the only useful vacuum module is the one located at the top right corner of the holding structure 3. Finally, the mounting table 1 can also be used for other types of panel assembly such as the panel 7 of FIG. 17 and FIG. 18. In this case, the panel is large since it spans on approximatively half of the holding structure 3, but it is rather light since it does not cover the holding structure on the whole part of its span. Such panel can be used to provide a door or a window in the construction system. Only the relevant vacuum modules (i.e. the modules that are at least partially covered by the panel to be assembled) can be used. In each of these situations, the weight of the overall panel assembly 5 can be held by the mounting table 1.

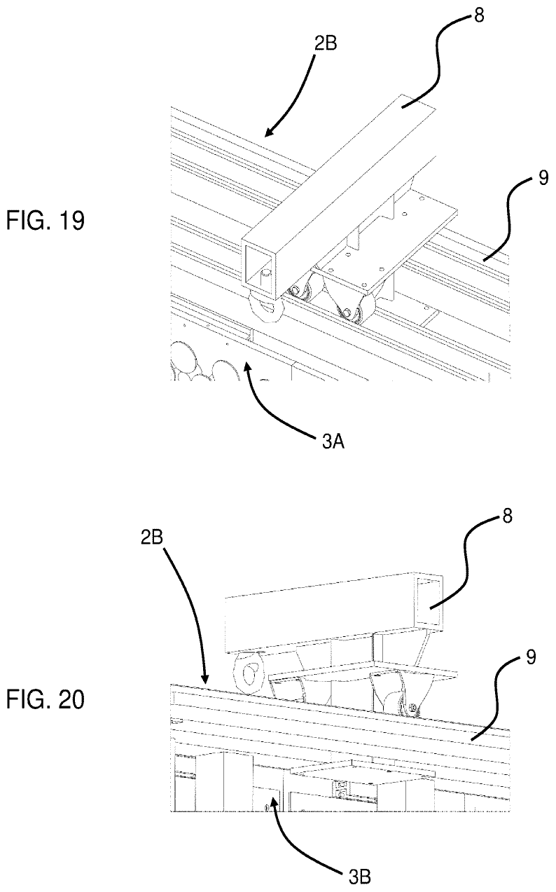

In order to prevent or reduce hazardous falling of the panel assembly, such as when a heavy panel is assembled, a fail-safe mechanism 8 can be provided on the top side of the framework 2C. Such mechanism is visible on FIG. 19 and FIG. 20. This fail-safe mechanism 8 is fixed to the panel assembly 5. It sits on rails 9, and it is arranged in order to roll along the rails in order to be positioned above the center of gravity of the panel assembly 5. By doing so, the fail-safe mechanism 8 is designed to counteract a possible of the suctions cups (e.g. because the vacuum pump does not generate vacuum through the suction cups anymore) during the assembling, so it can limit the (already reduced) risks of falling of the panel assembly.

Alternatively, the fail-safe mechanism 8 may also be an overhead crane, if already available in the building. However, in case no crane is available, it may be an independent self-sustained mechanism with rails.

Thanks to the fail-safe mechanism 8, in case the system encounters the worst-case scenario, in which the heavy panel is not secured by the suction cups, the heavy panel assembly will not fall down and will remain sustained. Experiments indeed show that the elements of the panel assembly may have no more “grip” with the suction cups at some point in time, especially when positive air pressure fills in the cups (because of vacuum missing), so the whole panel may slide downwards.

Optionally, this secured connection with the fail-safe mechanism 8 is taking place early during the assembly cycle, i.e. when assembling the second layer of the panel assembly as this is the earliest point in time when the panel assembly becomes linked and closed (the first layer is still a set of individual elements). Indeed, when only the first layer is assembled, a failure would be relatively acceptable as the overall weight of the panel assembly is still low at that stage.

The mounting table 1 of the disclosure can be used as holding means in a more global system intended for manufacturing a panel assembly 5. In addition to the mounting table 1, such system includes a set of robots arranged to assemble each layer of the panel assembly 5, from the front side of the holding structure 3A.

The panel assembly can be manufactured according to the following steps, layer after layer, starting from the front side of the panel assembly (the first layer 50) secured to the front side of the holding structure 3A, and operating on the back side of the panel assembly, from the second to the last layer.

In details, a vacuum is generated through the suction cups 30, the channel 32 and the air outlet 33. This vacuum is constantly generated by means of the vacuum pump, as long as the panel assembly needs to be secured on the holding structure 3. In case it is divided into a set of vacuum modules 3.1, 3.2 . . . , 3.N . . . , the vacuum is constantly generated only in the relevant vacuum modules. After this first step, the first layer can be secured to the front side of the holding structure 3A, as the wooden elements of this first layer can be secured by the vacuum generated at the level of the suction cups 30 in contact with this wooden element. The same applies for each wooden element of the first layer, and also with each insulation element thereof, until all the wooden elements and the insulation elements of the first layer are arranged on the suction cups 30.

Then similar steps apply to the other layers 51, 52, 53 . . . . The steps for the assembling of a given layer maybe considered as forming an “assembling cycle”. In details, the robots can grip, handle and position the elements of the second layer, on the appropriate position on the first layer. Then, each element can be secured to the first layer. In case of wooden elements, they may be secured to wooden elements of the first layer by means of screws inserted through the elements in contact. In case of insulation elements, they can just be positioned correctly, then they will be simply “trapped” within wooden elements close to each other. The same cycle is repeated for each subsequent layer, thereby securing it on the preceding layer, until the last layer is secured, and the panel is thus assembled.

During this manufacturing process, the first layer 50 was the one from which the whole panel assembly 5 was maintained at least partially vertically to the holding structure 3. The suction cups 30 and the spacers 31 were adapted to ensure that the whole panel assembly 5 was maintained at the level of the first layer 50. The robots could thus operate on the back side of the panel assembly.

Finally, after the panel assembly 5 is completed, it can be released in order to be stored and transported. This can be simply done by inhibiting the vacuum in the holding structure 3. Since the panel was assembled in a vertical (or an almost vertical) orientation, it does not need to be flipped.

This process can be improved by provided the mounting table 1 with a self-cleaning mechanism (not represented on the drawings), which is arranged to sneeze out any possible dust particle that may have been collected during the assembling cycle of the panel assembly. This mechanism is arranged to continuously intaking air to generate vacuum, so air and dust particles can be sneezed out. In details, this mechanism includes an electrically controlled valve which is operated to switch between three air states which can be used along the assembling process. The first state is “off”, which means that no air is circulating. The second state is “vacuum”, which means that the vacuum is generated in order to secure the panel. The third state is “sneeze out”, which means that the all the suction cups that are not useful for the securing of the panel assembly 5 can be used to sneeze out dust particles. The switch between those three states can be made at the vacuum module level, along each assembling cycle, in order to both secure the panel assembly and avoid that dust particles be trapped within the panel assembly.

1-15. (canceled)

16. A mounting table for manufacturing a panel assembly, the panel assembly including a plurality of superimposed layers secured to each other, a front side of the panel assembly being arrangeable on the mounting table so that the panel assembly can be assembled from a back side of the panel assembly, the mounting table comprising:
a holding structure oriented at least partially vertically, the holding structure having a front side and a back side,
a set of suction cups secured to the front side of the holding structure,
a set of fixed spacers secured to the front side of the holding structure (3A), the fixed spacers being arranged between suction cups,
means for generating vacuum within the suction cups, said means for generating vacuum within the suction cups being arranged on the back side of the holding structure, the mounting table being arranged:
so that a first layer of the panel assembly can be secured at least partially vertically to the front side of the holding structure by means of the suction cups, while one or more following layers can be securely attached to each other to form the plurality of superimposed layers, and
so that a weight of the overall panel assembly can be held by the mounting table.

17. The mounting table according to claim 16, wherein the spacers are distributed homogeneously along the front side of the holding structure.

18. The mounting table according to claim 16, wherein the holding structure is divided into a set of vacuum modules with vacuum capacities that are adaptable separately from one another.

19. The mounting table according to claim 17, wherein in each vacuum module the suction cups are arranged in a matrix of rows and columns.

20. The mounting table according to claim 16, wherein the first layer of the panel assembly includes a series of wooden elements and insulation elements, and wherein a size of the suction cups and a distance between two adjacent suction cups are determined so that the wooden elements and the insulation elements can be held by at least some of the suction cups.

21. The mounting table according to claim 16, wherein the spacers include a hardened heavy-duty rubber portion sustained by a steel body attached to the holding structure.

22. The mounting table according to claim 16, being configured to intake air to generate vacuum during manufacturing of the panel, the table including a self-cleaning mechanism arranged to sneeze out one or more dust particles collected during the manufacturing of the panel assembly.

23. The mounting table according to claim 22, comprising an electrically controlled valve that is operable to switch between an “off” air state, a “vacuum” air state, and a “sneeze out” air state, and the valve being programmed to handle different phases of the manufacturing of the panel assembly.

24. The mounting table according to claim 16, comprising a framework on which the holding structure is attached, and a fail-safe mechanism arranged on a top side of the framework, in order to fix the panel assembly and counteract a possible failure of the suction cups.

25. The mounting table according to claim 24, wherein the table comprises rails on which the fail-safe mechanism sits on rails, and the fail-safe mechanism is arranged in order to roll along the rails in order to be positioned above a center of gravity of the panel assembly.

26. The mounting table according to claim 16, wherein the holding structure is vertically oriented.

27. A system for manufacturing a panel assembly, the system including a mounting table according to claim 16 and a set of one or more robots arranged to assemble each layer of the panel assembly.

28. A method for manufacturing a panel assembly by means of a system according to claim 27, including the steps of:
generating a constant vacuum through the suction cups;
arranging the first layer on the suction cups;
arranging each following layer on the preceding layer; and
securing the adjacent layers to each other.

29. A panel assembly obtainable via the method of claim 28.

30. The mounting table of claim 16, wherein the spacers of the set of fixed spacers are configured to mitigate elastic deflection of the suction cups along a gravity direction due to the weight of the panel assembly.

31. The mounting table of claim 16, wherein the mounting table is arranged so that the first layer of the panel assembly can be secured vertically by its front side to the front side of the holding structure by means of the suction cups, while the one or more following layers can be securely attached to each other to form the plurality of superimposed layers.

32. The mounting table of claim 31, wherein the spacers of the set of fixed spacers are configured to mitigate elastic deflection of the suction cups along a gravity direction due to the weight of the panel assembly.

33. The mounting table of claim 26, wherein the mounting table is arranged so that the first layer of the panel assembly can be secured vertically by its front side to the front side of the holding structure by means of the suction cups, while the one or more following layers can be securely attached to each other to form the plurality of superimposed layers.

34. The mounting table of claim 32, wherein the spacers of the set of fixed spacers are configured to mitigate elastic deflection of the suction cups along a gravity direction due to the weight of the panel assembly.
